(19) United States
(12) Patent Application Publication
(10) Pub. No.: US 2023/0356453 A1
(43) Pub. Date: Nov. 9, 2023

(54) MACHINE AND PROCESS FOR BENDING THERMOPLASTIC TUBE

(71) Applicants: Domenico Fulco, Arosio (CO) (IT); Alessandro Pace, Arosio (CO) (IT)

(72) Inventors: Domenico Fulco, Arosio (CO) (IT); Alessandro Pace, Arosio (CO) (IT)

(21) Appl. No.: 18/139,796

(22) Filed: Apr. 26, 2023

(30) Foreign Application Priority Data
May 5, 2022 (IT) 102022000009221

(51) Int. Cl. B29C 53/08; B29C 53/84

(52) U.S. Cl. CPC B29C 53/083; B29C 53/84

(57) ABSTRACT

A machine and a process for bending filiform thermoplastic material, such as a tube, by using a machine for bending tubes provided with a heating apparatus governed by a programmable control unit with a core body positionable inside the portion of the tube to be bent, suitable for being heated in a sector-by-sector basis, said sectors being independent of each other and heatable independently of each other.

This application claims priority to Italian application No. 102022000009221 filed on 5 May 2022 which is incorporated by reference in its entirety

### OBJECT OF THE INVENTION

The object of the present invention is a machine and a process for bending thermoplastic tubes.

### Present Status of the Art

Thermoplastic tubes are used to convey liquids and vapours in many applications. These tubes have very stable proprieties in a variety of heath and light conditions and are consequently suitable for transporting a wide range of liquids for a wide range of applications, think, by way of non-limiting example, to the automotive sector and specifically to transportation of fuel and vapours thereof.

In the various applications adopted by the various production industries, tubes shall be bent with various bend radii, bending rotations and distances between the various curves. This bending process requires a sequence of heating, bending, and cooling operations on portions of the tube to be bent.

Many methods are in use for bending thermoplastic tubes. In the known bending methods, the tube, in its straight form, is heated with hot air or other means. The tube is cold inserted into moulded dies manually by forcing its position and is subsequently connected to a device that blows hot and cold air alternatively, in order to model and cool the tube. Once the desired shape of the tube is obtained, this one is removed from the shaping tool.

This bending method is very delicate, and the tools used are expensive and not easily re-configurable.

A thermoplastic tube bending method is also known in which, while a pre-heated portion of the tube is bent and cooled, another portion of the tube is heated in order for it to be subsequently bent and cooled, and so on for all specified working cycles of the tube to be bent.

A drawback of this further thermoplastic tube portion bending method is in that the time duration of a tube portion bending and cooling phase is, in most cases, longer than the time duration of the heating phase of the other portion of the tube to be bent. Remember that the portion of the tube to be bent shall be sufficiently heated in order to render the tube sufficiently plastic for being bent, but at the same time the portion of the tube shall not lose its original cold structure and shape. Therefore, the heating phase is a very delicate one. Bringing to, but even more important maintaining the portion of the tube to be bent at the desired heating temperature in order to render it sufficiently plastic for bending for the time duration necessary for submitting another portion of the tube to bending and cooling entails major drawbacks.

In order to overcome the drawbacks of the known methods, the present invention provides a new and advantageous machine for bending filiform thermoplastic materials, such as a thermoplastic tube, to embody a new and advantageous filiform thermoplastic material such as a tube, here below simply referred to as “tube”, bending process by heating a bending core heated and positioned inside the tube to be bent, capable of heating the portion of the tube to be bent and of recovering of the thermal energy in excess to prepare the subsequent portion of the tube to be heated and bent. Said method according to the present invention allows to bend the tube while preventing waste of energy. Such bending core is formed of a set of sectors that can be heated in an independent and programmable manner. Said bending machine and procedure are better described in the following paragraphs.

### DESCRIPTION OF THE INVENTION

Thanks to this innovative and advantageous bending process, tube bending can be performed by using a new and advantageous tube bending machine which comprises a tube positioner assembly, a bending head provided with a tube blocking device, at least one die, at least one contrast device, and a puller assembly connected to a tie rod. Said tie rod, moved by the puller, is integrally connected to a core body in order for said core body to be positioned inside the tube to be bent. The positioning of the core body inside the tube to be bent aims at heating the portion of the tube to be bent, as better illustrated here below, in order to render the portion of the tube to be bent sufficiently plastic for being advantageously bent accurately and with an optimum quality of bending and of the bent thermoplastic material.

The core body is heated by using a heating apparatus, preferably an induction one comprising an inductor device such as an induction coil. Said heating apparatus might also be formed, for example, of a set of electrical resistors and could in any way consist of any heating apparatus. Said heating apparatus is governed by a programmable control unit. Said programmable control unit is suitable for giving instructions to the heating apparatus for selecting the sectors of the core body to be heated and the temperature the sectors should reach on the basis of a predetermined working program, by receiving a signal that represents the temperature reached by the portion of the heated core body and/or from the portion of the tube to be bent from a temperature sensor, which every sector of the core body is provided with.

In order to better select the portions of the core body to be heated, while preventing energy dispersion, and to concentrate the core body heating only in the section of interest and consequently to only heat the portion of the tube to be bent, a suitable core body is formed of at least two sectors independent of each other.

While bending the portion of the tube to be bent, it is necessary to be in a position to calibrate said portion of the tube. Said calibration is implemented by a set of articulated elements suitable for performing such calibration of the portion of the tube to be bent, which are positioned at one end of the core body, specifically in that portion which is opposed to the point of contact of the core body with the tie rod.

Upon finishing the bending process of the portion to be bent, the bent portion of the tube is still in its plastic status and needs to come back to a rigid status by cooling, an operation that is facilitated and speeded up by way of an air cooling device.

The machine for bending tubes described here above is suitable for implementing an innovative and advantageous bending process on a thermoplastic tube, which comprises eight phases.

In the first phase of said process, the portion of the tube to be bent is positioned in the bending area interposed between the die of the bending head and the contrast device by way of a positioner assembly, which a heating apparatus, preferably an induction one comprising an inductor device such as an induction coil, is connected to. Said heating apparatus is governed by a programmable control unit, whereby a core body is heated according to a specific program. The core body is positioned inside the thermoplastic tube by way of a tie rod moved by a puller assembly, said core body being integral with the tie rod. Said core body is formed of at least two sectors independent of each other.

In the second phase of the process, the portion of the tube to be bent is blocked by a blocking device mounted on the bending head.

In the third phase of the process, the portion of the tube to be bent is heated by way of a heating apparatus, preferably an inductor device, which heats the portion of the tube to be bent through the heating of one or several sectors of the core body depending on the portion of the tube to be bent. Such capability of heating each of said sectors independently of each other is implemented by the heating apparatus, said heating apparatus being governed by the programmable control unit which continuously receives a signal that represents the temperature reached by the sectors submitted to heating and/or the temperature of the tube to be bent from a temperature sensor, which every sector of the core body is provided with. The intensity of the heating provided by the heating apparatus of the various sectors of the core body is controlled and governed according to a specific program by the programmable control unit, which modifies the heating intensity according to a signal that represents the temperature reached by the individual sectors and/or the temperature of the portion of the tube to be bent. Such signal is continuously sent by the temperature sensor which every sector of the core body is provided with.

In the fourth phase of the process, the positioner assembly is retracted to reach a position outside the bending area, once the portion of the tube to be bent reaches a temperature suitable for rendering the portion of the tube to be bent sufficiently plastic for being bent.

In the fifth phase of the process, the portion of the tube to be bent is positioned inside the throat of the die and is blocked in said portion of the tube to be bent by way of a contrast device.

In the sixth phase of the process, the portion of the tube to be bent is bent byway of the movement of the bending head and the curve of the portion of the tube to be bent is calibrated by way of articulated elements placed at the end of the core body in a position opposed to the point of contact of the tie rod with the core body.

In the seventh phase of the process, the core body is retracted byway of the retraction of the puller assembly connected to the tie rod, said core body being integral with the tie rod, up to reaching the portion of the tube that will be subjected to the subsequent bending phase. In the same phase, the bent tube is cooled upon completion of the bending cycle. Such cooling takes place by way of a device used for air cooling the portion of the bent tube. Retracting the bending core in the portion of the tube to be bent during the subsequent cycle results in a sectorial passive heating action. Such sectorial passive heating allows to prepare the portion of the tube to be bent in the subsequent bending cycle a little bit before said portion of the tube starts its sectorial active heating phase aiming at bringing the latter portion of the tube to a temperature suitable for rendering it sufficiently plastic for being bent. Such retraction makes it possible to recover the residual heat of the bending core thus rendering the process more efficient.

In the eighth phase of the process, the device used to block the portion of the bent tube is released and the die, the contrast device, and the bending head are retracted to their rest positions in order to start a new bending process.

Then, once the mentioned eight phases are over, the process restarts from the first phase in order to bend a tube according to the predetermined working program, also governed by the mentioned programmable control unit.

### DESCRIPTION OF THE FIGURES

FIG. 1 shows a perspective schematic view of the bending area of the machine for bending tubes.

FIG. 2 shows the moving and positioning portion of the machine for bending tubes during the core body activation phase, in a bidimensional form.

FIG. 3 shows the portion of the machine for bending tubes related to the structure of the core body, in a bidimensional form.

FIG. 4 shows the first phase of the process according to the present invention.

FIG. 5 shows the second phase of the process according to the present invention.

FIG. 6 shows the third phase of the process according to the present invention.

FIG. 7 shows the fourth phase of the process according to the present invention.

FIG. 8 shows the fifth phase of the process according to the present invention.

FIG. 9 shows the sixth phase of the process according to the present invention.

FIG. 10 shows the eighth phase of the process according to the present invention.

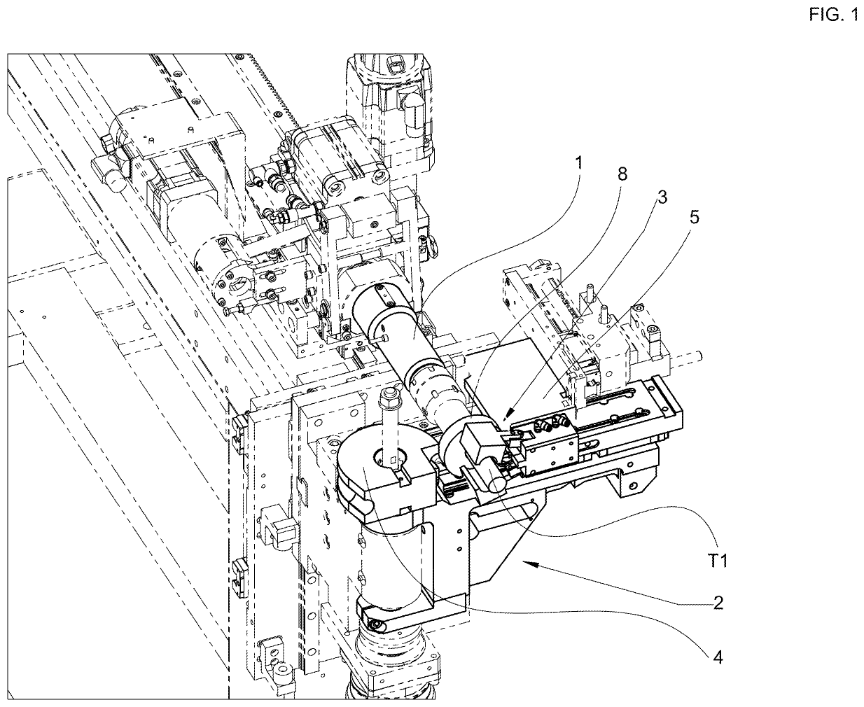

FIG. 1 shows the bending area of the machine for bending a thermoplastic tube. Said figure shows a tube positioner assembly (1), a bending head (2) provided with a tube blocking device (3), at least one die (4), at least one contrast device (5), and a heating apparatus (8), preferably an induction one comprising an inductor device such as an induction coil. Such heating apparatus (8) also comprises a programmable control unit (A), not shown in the figures, suitable for governing the heating apparatus (8). Said heating apparatus (8) is integrally connected to the positioner assembly (1).

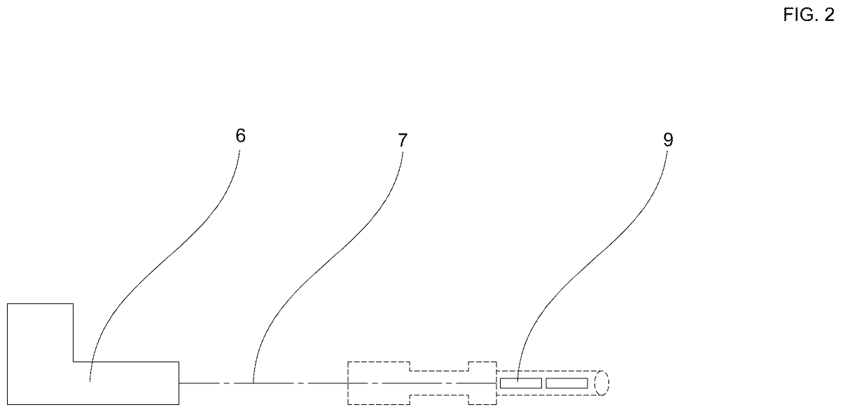

FIG. 2 shows a puller assembly (6) suitable for moving a tie rod (7) connected thereto and a core body (9) suitable for being heated and integrally connected to the tie rod (7).

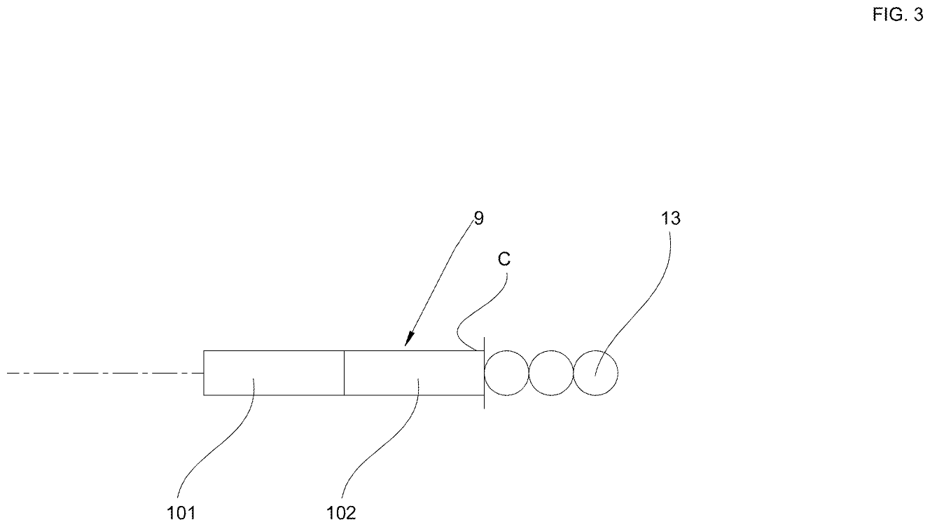

FIG. 3 shows the core body (9) suitable for being heated and formed of at least two sectors (101, 102) independent of each other.

FIG. 3 also shows a set of articulated elements (13) suitable for calibrating the portion of the tube to be bent (T1), not shown in the figures, positioned at one end (C) of the core body (9), also provided with an air cooling device (12) for cooling the bent tube (T2); none of said elements is shown in the figures.

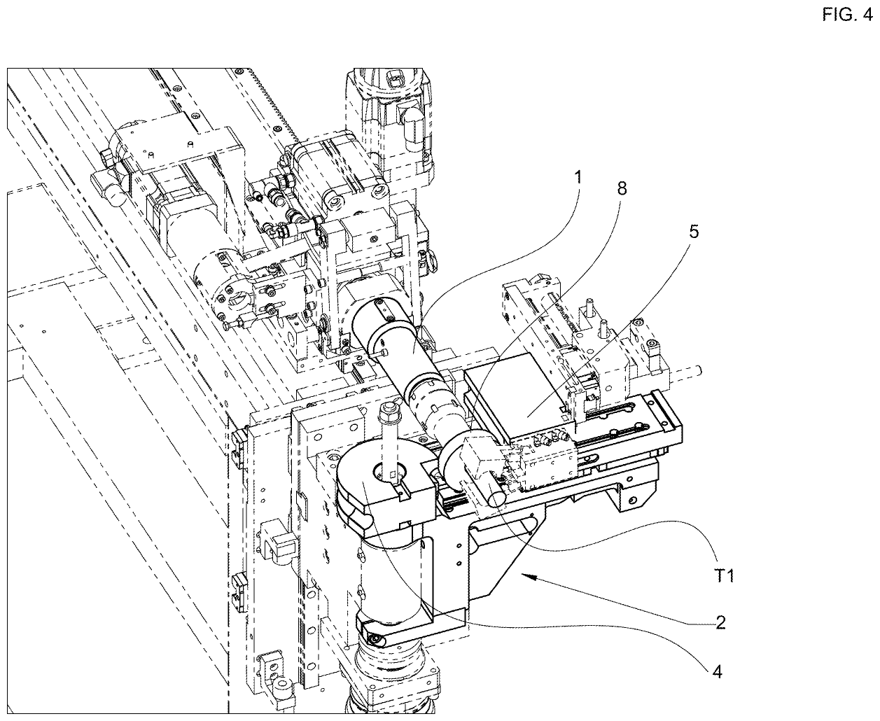

FIG. 4 shows the first phase of the process, whereby the portion of the tube to be bent (T1) is positioned in the bending area interposed between the die (4) of the bending head (2) and the contrast device (5) by way of the positioner assembly (1), which a heating apparatus (8), preferably an induction one comprising one inductor device such as an induction coil, and a programmable control unit (A), not shown in the figures, are connected to. This phase comprises the positioning of a core body (9), not shown in the figures, suitable for being heated, internally to the thermoplastic tube, said positioning being implemented by way of the tie rod (7), not shown in the figures, integrally connected to the puller assembly (6), not shown in the figures, said core body (9) being integral with the tie rod (7). Said core body (9) is formed of at least two sectors (101 and 102), not shown in the figures, independent of each other. Remember that the heating apparatus (8) is governed by the programmable control unit (A).

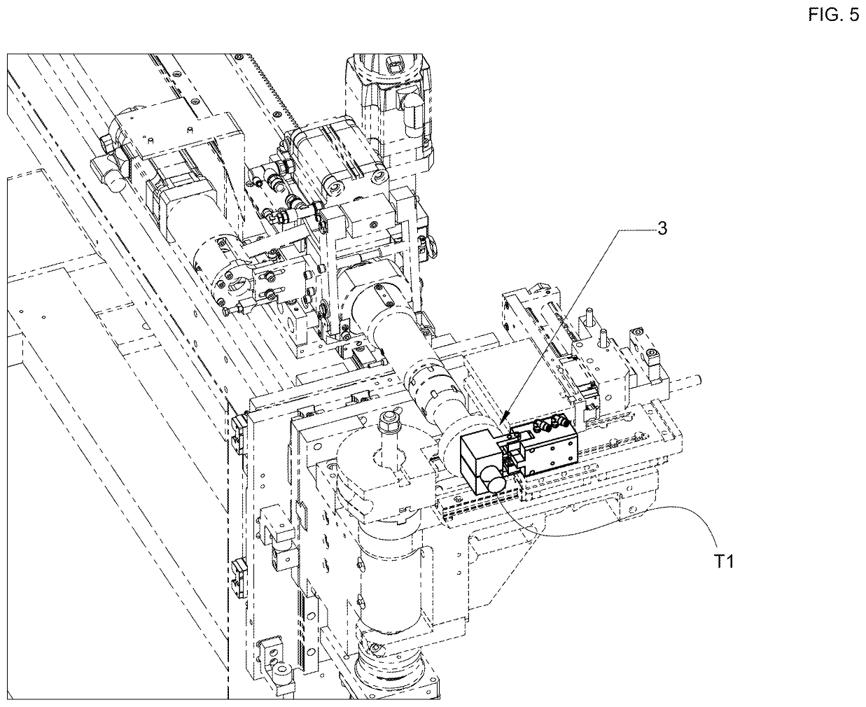

FIG. 5 shows the second phase of the process, whereby the portion of the tube to be bent (T1) is blocked by way of the blocking device (3).

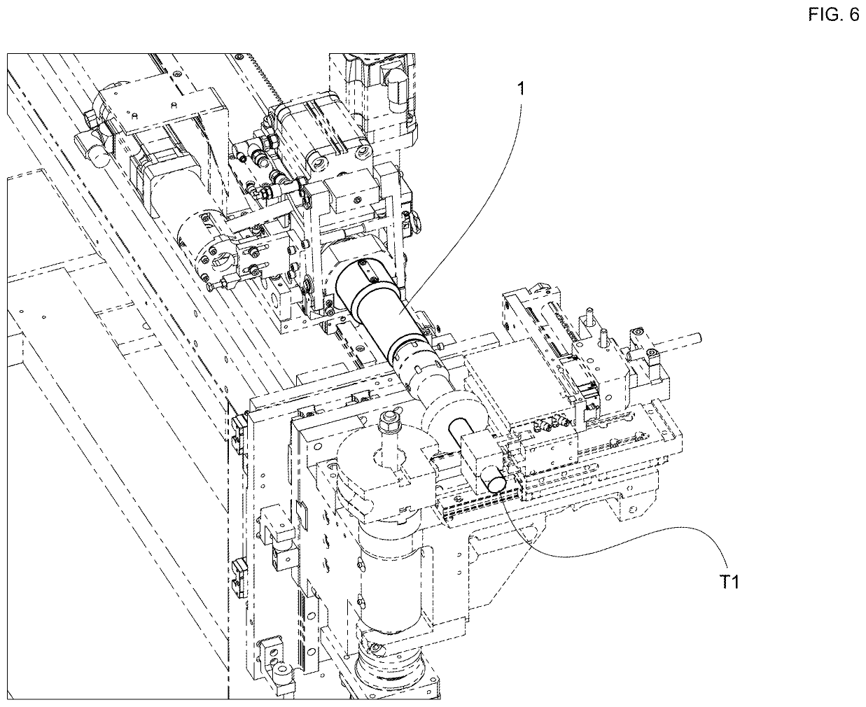

FIG. 6 shows the third phase of the process, whereby the portion of the tube to be bent (T1) is heated by way of the heating apparatus (8), which heats the portion of the tube to be bent (T1), preferably byway of the induction heating of one or more sectors (101 and 102) of the core body (9), not shown in the figures, the latter being internal to the tube to be bent, depending on the portion of the tube to be bent (T1), heating being possible independently for each of said sectors (101 and 102) of the heating apparatus (8), said heating apparatus (8) being governed by the programmable control unit (A), not shown in the figures, which continuously receives a signal that represents the temperature reached by the sectors (101 and 102) submitted to heating by the heating apparatus (8) and/or the temperature of the portion of the tube to be bent (T1) from the temperature sensor (B), not shown in the figures, which every sector of the core body (9) is provided with.

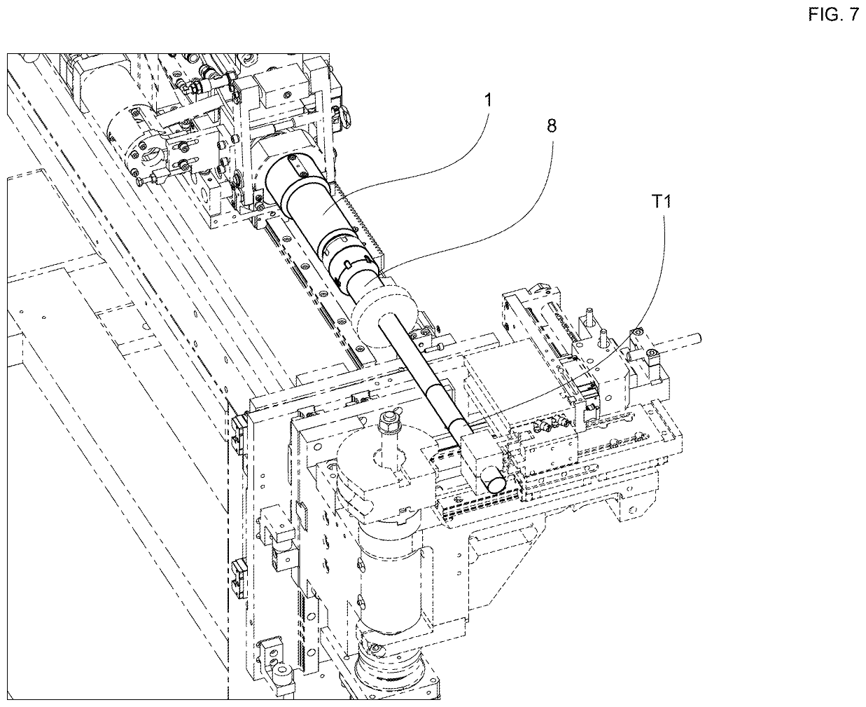

FIG. 7 shows the fourth phase of the process, whereby the positioner assembly (1) is retracted. Said retraction of the positioner assembly (1) positions it outside the bending area, once the portion of the tube to be bent (T1) reaches a temperature suitable for rendering the portion of the tube to be bent sufficiently plastic for being bent.

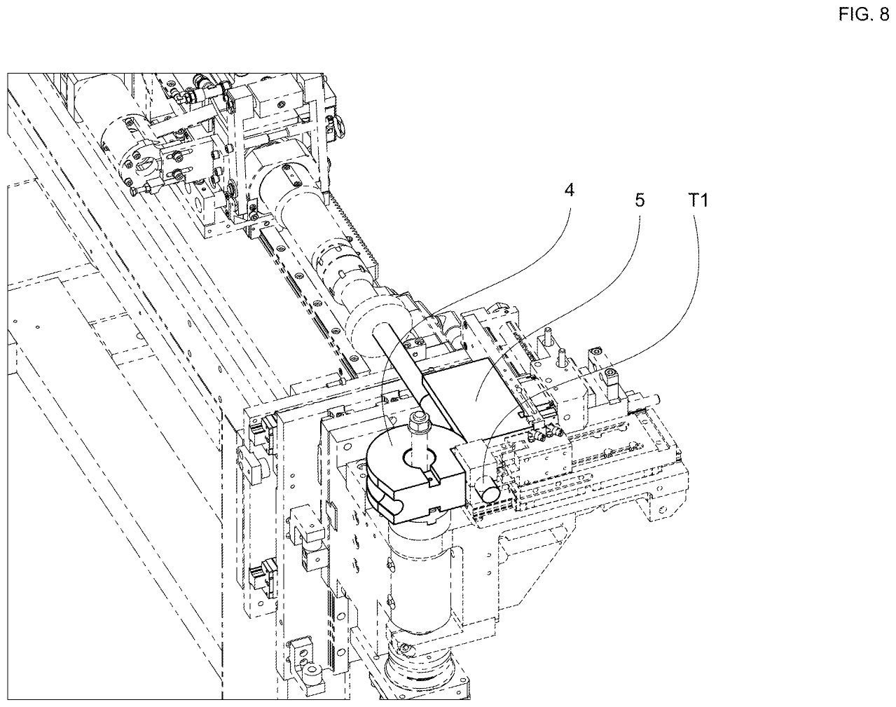

FIG. 8 shows the fifth phase of the process, whereby the portion of the tube to be bent (T1) is positioned inside the throat of the die (4) and said portion of the tube to be bent (T1) is blocked byway of a contrast device (5).

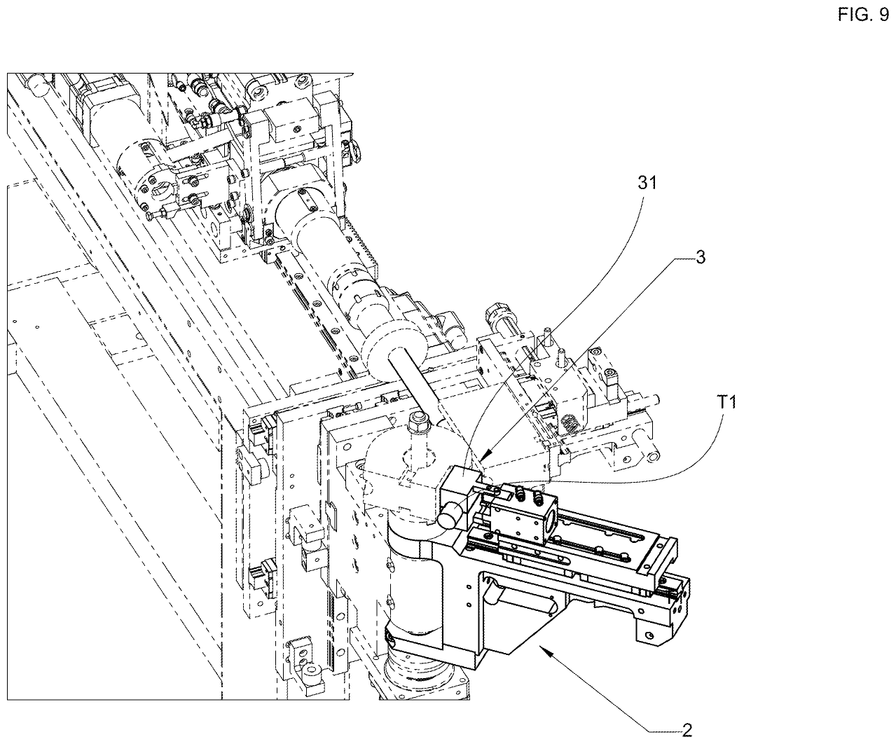

FIG. 9 shows the sixth phase of the process, whereby the portion of the tube to be bent (T1) is bent thanks to the movement of the bending head (2) and the curve of the portion of the tube to be bent (T1) is calibrated byway of articulated elements (13), not shown in the figures, placed at the end of the core body (9), not shown in the figures, in a position opposite to that of the point of contact of the tie rod (7) with the core body (9), not shown in the figures. For an easy identification of the position of said articulated elements (13), note that they are located in an internal proximity to the tube to be bent (T1), of the position of the gripper (31) of the blocking device (3).

The process continues with the seventh phase, not shown in the figures, whereby the core body (9) is retracted by way of the retraction of the puller assembly (6) connected to the tie rod (7), said core body (9) being integral with the tie rod (7), up to reaching the portion of the tube that will be submitted to the successive bending phase and the bent portion of the tube (T2) is cooled by way of an air cooling device (12) upon completion of the bending cycle.

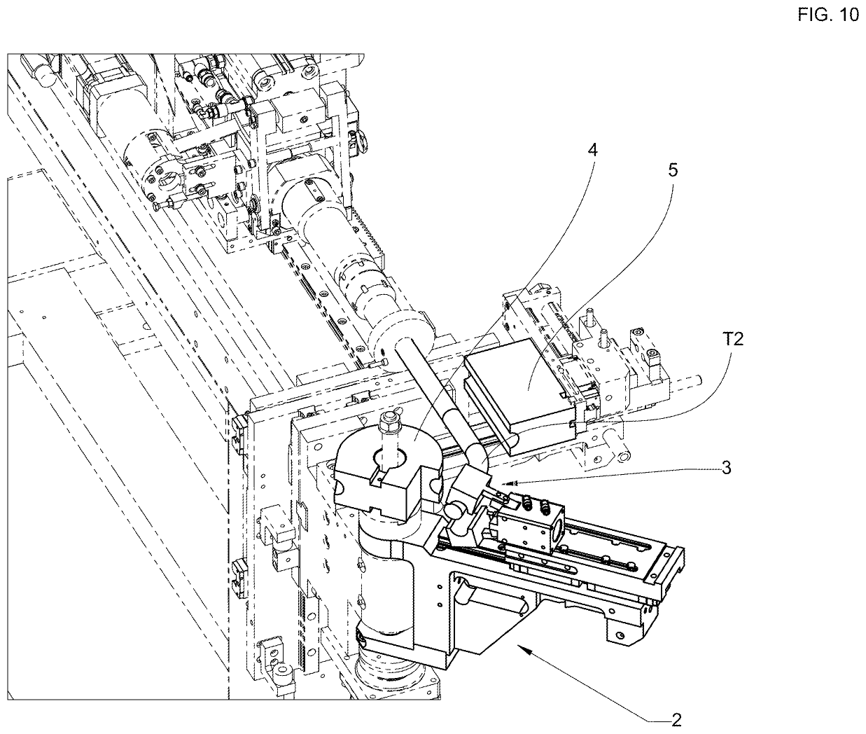

FIG. 10 shows the eighth phase of the bending process, whereby the blocking device (3) is released (3) from the bent portion of the tube (T2) and the die (4) and the contrast device (5) and the bending head (2) are retracted to their rest position in order to start a new bending process.

1. A machine for bending a thermoplastic tube comprising:
a tube positioning unit;
a bending head provided with a tube block device;
at least one die;
at least one contrast device;
a puller unit connected to a tie rod;
a heating apparatus;
a programmable control unit configured and arranged for controlling the heating apparatus; and
a core body including at least two sectors, wherein each of said sectors of the core body is configured and arranged to be independently heated via the heating apparatus.

2. The machine for bending a thermoplastic tube according to claim 1 wherein, the heating apparatus is governed by the programmable control unit, which gives instructions for selecting the sectors of the core body to be heated.

3. The machine for bending a thermoplastic tube according to claim 1, wherein the heating apparatus comprises an induction equipment comprising an inductor device that includes at least one induction coil.

4. The machine for bending a thermoplastic tube according to claim 1, wherein the core body is configured and arranged to be heated and it is solidly connected to the tie rod.

5. The machine for bending a thermoplastic tube according to claim 4, wherein a series of articulated elements configured and arranged for calibrating the portion of the tube to be bent are positioned at one end of the core body.

6. The machine for bending a thermoplastic tube according to claim 4, wherein the core body is formed of two of said sectors, which are independent of each other.

7. The machine for bending a thermoplastic tube material according to claim 1, wherein the at least two sectors are each provided with a temperature sensor configured and arranged for sending signals representing a temperature to the programmable control unit.

8. The machine for bending a thermoplastic tube according to claim 1, wherein the core body is provided with a device for air cooling of the tube after a portion of said tube has been bent.

9. A process for bending a thermoplastic a tube by means of the machine according to claim 1, comprising the following steps:
first step of positioning of the portion of the tube to be bent in a bending area placed between the die of the bending head and the contrast device by the tube positioning unit to which is connected the heating apparatus and a programmable control unit and positioning the core body inside the thermoplastic tube, said positioning being realized by the tie rod connected to the puller unit and said core body being connected to the tie rod, wherein said core body is formed of two sectors which are independent from each other and are each configured and arranged to be heated by the heating apparatus that is controlled by the programmable control unit;
a second step of blocking a portion of the tube to be bent by the block device;
a third step of heating of the portion of the tube to be bent by the heating device, which heats the portion of the tube to be bent by heating one or more sectors of the core body according to the portion of the tube to be bent via the heating device, wherein said heating device is governed by the programmable control unit which continuously receives from a temperature sensor associated with each sector of the core body, the signal representing the temperature reached by the associated sector subjected to heating by the heating device and/or the temperature of the tube to be bent;
a fourth step of retracting the positioner unit out of the bending area when the portion of the tube to be bent has reached the temperature to make the portion of tube to be bent sufficiently plastic to be bent;
a fifth step of positioning the portion of the tube to be bent inside a throat of the die and clamping said portion of the tube to be bent by the contrast device (5);
a sixth step of bending of the portion of the tube to be bent by the movement of the bending head and calibrating the curve of the portion of the tube to be bent by articulated elements placed at an end of the core body that is opposite to the point of contact of the tie rod with the core body (9);
a seventh step of the retracting the core body via the retraction of the extractor unit connected to the tie rod, wherein said core body is connected to the tie rod at the portion of the tube that will be subject to the next step of bending and cooling of the bent portion of tube at the completion of the bending cycle by an air cooling device (12); and
an eighth step of releasing the tube block device from the portion of the bent tube, retracting the die and the contrast device and the bending head to a rest position to begin a new bending process.
